(19) United States
(12) Patent Application Publication
(10) Pub. No.: US 2010/0128134 A1
(43) Pub. Date: May 27, 2010

(54) PHOTOGRAPHIC APPARATUS WITH ANTI-SHAKE FUNCTION

(76) Inventor: Chih-Yi YANG, Taipei City (TW)

Correspondence Address: HDLS Patent & Trademark Services, P.O. BOX 220746, CHANTILLY, VA, 20153-0746, US

(21) Appl. No.: 12/579,511

(22) Filed: Oct. 15, 2009

(30) Foreign Application Priority Data
Nov. 24, 2008 (TW) 097221007

(51) Int. Cl. H04N 5/228; G03B 17/00

(52) U.S. Cl. 348/208.6; 396/55; 348/E05.031

(57) ABSTRACT

A photographic apparatus with an anti-shake function includes an image sensing unit, a shake parameter detecting unit, a processor module, and a driving unit. The shake parameter detecting unit detects a shake parameter, and the shake parameter is digitized and calculated to produce a shake compensating signal through the processor module. Finally, the driving unit receives the shake compensating signal and to adjust a position of the image sensing unit according to the shake compensating signal. Whereby, the photographic apparatus can detect regular shake, such as a human heartbeat rhythm or a human muscle rhythm to predict the direction and magnitude of the shake. Also the detected shake parameter can be calculated and compensated to reduce failure rate of photographing indistinct photos due to the regular shake.

### BACKGROUND OF THE INVENTION

1. Field of the Invention

The present invention relates to a photographic apparatus, and more particularly to a photographic apparatus with an anti-shake function.

2. Description of Prior Art

Along with the process of optoelectronic technology, the electronic and digitalized photography technology is progressively developing and is integrated with the electronic technology. The digital camera technology is a combination of optics, precision machine, and electronic technology. Also, due to the lower cost of components of the digital camera, the digital camera has been targeting consumers and enterprises. Hence, the digital camera is not a demand only for a professional photographer, furthermore, it has requisite been already turned into the indispensable necessities in daily life for an individual.

For the operation of the camera, the influence of photographing quality is greatly increased due to camera shake, especially, when the subject distance is short. Hence, the camera tripod is necessary to help to create a firm platform for a long period of capturing time to take good pictures, especially, when the camera without an anti-shake function. However, the camera tripod is unavailable and inappropriate in some conditions. Hence, reducing the intensity of a shake to take good pictures is based on a stable, balanced pose and force.

However, the regular shake, such as a human heartbeat rhythm or a human muscle rhythm, can not be eliminated by any physical means, even though the stable, balanced pose and force are considered. For this reason, it is to increase failure rate of photographing indistinct photos due to the regular shake.

Accordingly, a photographic apparatus with an anti-shake function is provided to solve the above-mentioned disadvantages.

### SUMMARY OF THE INVENTION

In order to solve the above-mentioned problems, the present invention provides a photographic apparatus with an anti-shake function. The photographic apparatus includes an image sensing unit, a shake parameter detecting unit, a processor module, and a driving unit. The image sensing unit is disposed in the photographic apparatus to capture images. The shake parameter detecting unit is disposed in the photographic apparatus to detect a shake parameter. The processor module is electrically connected to the shake parameter detecting unit to process the shake parameter and produce a shake compensating signal. The driving unit is electrically connected between the processor module and the image sensing unit to receive the shake compensating signal and to adjust a position of the image sensing unit according to the shake compensating signal.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic view of a photographic apparatus with an anti-shake function according to the present invention; and

FIG. 2 is a block diagram of the photographic apparatus.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

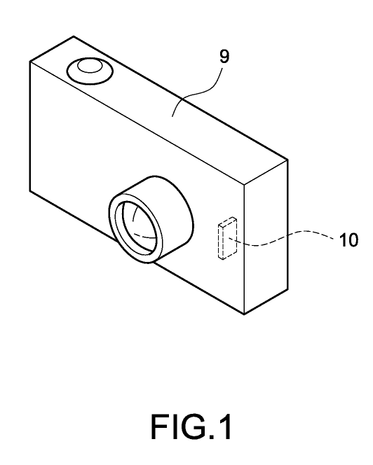

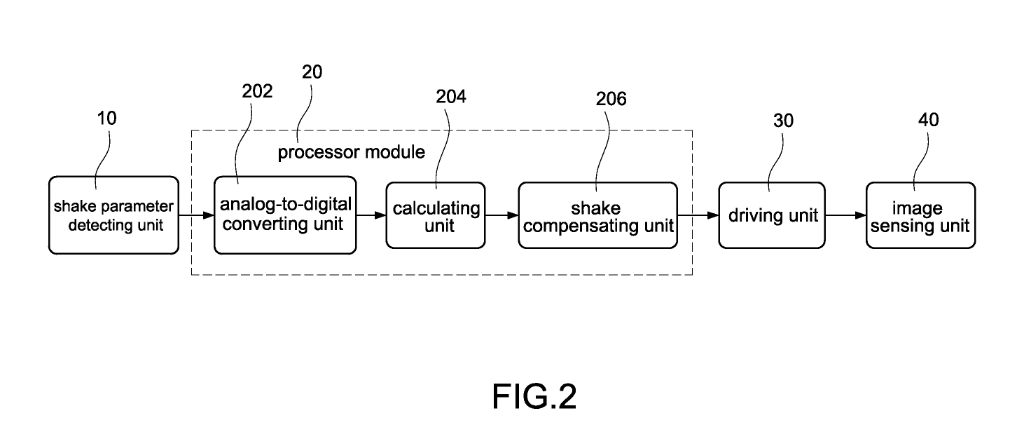

Reference will now be made to the drawing figures to describe the present invention in detail. Reference is made to FIG. 1 and FIG. 2 which are a schematic view and a block diagram of a photographic apparatus with an anti-shake function according to the present invention, respectively. The photographic apparatus 9 includes an image sensing unit 40, a shake parameter detecting unit 10, a processor module 20, and a driving unit 30.

The image sensing unit 40 is disposed in the photographic apparatus 9 to capture images. The image sensing unit 40 can be a CMOS image sensor or a CCD image sensor. The shake parameter detecting unit 10 is disposed in the photographic apparatus 9 to detect a shake parameter. The shake parameter can be a heartbeat rhythm parameter or a muscle rhythm parameter. The processor module 20 is electrically connected to the shake parameter detecting unit 10 to process the shake parameter to produce a shake compensating signal.

The processor module 20 includes an analog-to-digital converting unit 202, a calculating unit 204, and a shake compensating unit 206. The analog-to-digital converting unit 202 is provided to receive the shake parameter and to digitize the shake parameter to produce a digital shake value. The calculating unit 204 is electrically connected to the analog-to-digital converting unit 202 to calculate the digital shake value to produce a digital shake direction value and a digital shake magnitude value. The shake compensating unit 206 is electrically connected to the calculating unit 204 to produce the shake compensating signal according to the digital shake direction value and a digital shake magnitude value.

The driving unit 30 is electrically connected between the processor module 20 and the image sensing unit 40 to receive the shake compensating signal and to adjust a position of the image sensing unit 40 according to the shake compensating signal.

In conclusion, the photographic apparatus with an anti-shake function of the present invention has the following advantages:

1. The shake parameter detecting unit 10 can detect regular shake, such as a human heartbeat rhythm or a human muscle rhythm to predict the direction and magnitude of the shake to the photographic apparatus 9.

2. The detected shake parameter is calculated and compensated through the processor module 20 to restrain the influence of the human heartbeat rhythm or the human muscle rhythm to the photographic apparatus 9.

Although the present invention has been described with reference to the preferred embodiment thereof, it will be understood that the invention is not limited to the details thereof Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A photographic apparatus with an anti-shake function, comprising:
an image sensing unit disposed in the photographic apparatus to capture images;
a shake parameter detecting unit disposed in the photographic apparatus to detect a shake parameter;
a processor module electrically connected to the shake parameter detecting unit to process the shake parameter and produce a shake compensating signal; and
a driving unit electrically connected between the processor module and the image sensing unit to receive the shake compensating signal and to adjust a position of the image sensing unit according to the shake compensating signal.

2. The photographic apparatus in claim 1, wherein the processor module comprises:
an analog-to-digital converting unit provided receive the shake parameter and to digitize the shake parameter to produce a digital shake value;
a calculating unit electrically connected to the analog-to-digital converting unit to calculate the digital shake value to produce a digital shake direction value and a digital shake magnitude value; and
a shake compensating unit electrically connected to the calculating unit to produce the shake compensating signal according to the digital shake direction value and a digital shake magnitude value.

3. The photographic apparatus in claim 1, wherein the shake parameter is a heartbeat rhythm parameter.

4. The photographic apparatus in claim 1, wherein the shake parameter is a muscle rhythm parameter.

5. The photographic apparatus in claim 1, wherein the image sensing unit is a CMOS image sensor.

6. The photographic apparatus in claim 1, wherein the image sensing unit is a CCD image sensor.
